(19) United States
(12) Patent Application Publication
(10) Pub. No.: US 2011/0236277 A1
(43) Pub. Date: Sep. 29, 2011

(54) MICROFLUID CONTROL DEVICE AND METHOD OF MANUFACTURING THE SAME

(75) Inventors: Dae Sik LEE, Daejeon (KR); Hyun Woo Song, Daejeon (KR); Kwang Hyo Chung, Daejeon (KR); Seon Hee Park, Daejeon (KR); Moon Youn Jung, Daejeon (KR); Seung Hwan Kim, Daejeon (KR)

(73) Assignee: Electronics and Telecommunications Research Institute, Daejeon (KR)

(21) Appl. No.: 13/050,106

(22) Filed: Mar. 17, 2011

(30) Foreign Application Priority Data
Mar. 24, 2010 (KR) 10-2010-0026154
Aug. 12, 2010 (KR) 10-2010-0077699

(51) Int. Cl. B01L 3/00; B32B 37/02; B32B 37/12; B29C 65/06; B32B 38/06; B32B 38/00; B29C 33/38

(52) U.S. Cl. 422/506; 422/502; 156/245; 156/73.5; 156/150; 156/219; 216/37

(57) ABSTRACT

Provided are a plastic microfluid control device having a multi-step microchannel and a method of manufacturing the same. The device includes a lower substrate, and a fluid channel substrate contacting the lower substrate and having a multi-step microchannel having at least two depths in a side coupling to the lower substrate. Thus, the device can precisely control the fluid flow by controlling capillary force in a depth direction of the channel by controlling the fluid using the multi-step microchannel having various channel depths. A multi-step micropattern is formed by repeating photolithography and transferred, thereby easily forming the multi-step microchannel having an even surface and a precisely controlled height.

### CROSS-REFERENCE TO RELATED APPLICATION

This application claims priority to and the benefit of Korean Patent Application Nos. 10-2010-0026154 filed Mar. 24, 2010, and 10-2010-0077699 filed Aug. 12, 2010, the disclosure of which is incorporated herein by reference in its entirety.

### BACKGROUND

1. Field of the Invention

The present invention relates to a microfluid control device and a method of manufacturing the same, and more particularly, to a plastic microfluid control device having multi-step microchannels and a method of manufacturing the same.

2. Discussion of Related Art

Microfluid control devices are key components for a lab-on-a-chip, and are applied to various devices such as protein chips, DNA chips, drug delivery systems, micro total analysis systems, and micro reactors, which require precise fluid control.

Depending on a method of controlling a microfluid, a microfluid control device may be implemented using a microactuating method for implementing a plastic micro pump and valve on a fluid channel or chamber, an electrosmotic method for driving a fluid using electrosmosis generated by applying a voltage between a microfluid, or a capillary flow method.

For example, the microfluid control device using the capillary flow method controls the flow of a fluid and a flow rate using attraction or repulsion generated by surface tension between the internal surface of a micro tube and the fluid. When the fluid is controlled using capillary force, the microfluid control device does not need a separate actuator or additional power supply, and has little breakdown.

Recently, various structures of a microplastic microstructure applied to a fluid control device or biochip using capillary flow have been proposed. For example, a diagnostic biochip structure for delivering a sample using only flow by capillary force, sequentially having a reaction of the sample in a fluid channel and a chamber, and measuring an amount of the reaction of the sample by an optical method has been proposed. In addition, a method of generating capillary force by installing a hexagonal microcolumn having a uniform depth in a channel or controlling capillary force by regulating a width and angle of a channel having a uniform depth has been proposed.

Such a microfluid control device may be manufactured by precise machining such as a computer numerical control process or dry etching in a semiconductor process.

However, the precise machining provides a rough surface, and has a limit in formation of a micropattern. Thus, it is difficult to precisely control fluid using capillary force. Further, the manufacture of a microfluid control device using a semiconductor process has problems of a difficult process, high production time, and high production costs.

Meanwhile, since a microfluid control device used for diagnosing a disease is disposable, it is generally manufactured of a polymer. Conventionally, it has been manufactured by directly processing a polymer, or forming a mold and transferring the mold to a polymer.

However, the conventional microfluid control device using a polymer has difficulty in controlling the superficial shape of a microchannel. Due to static electricity or attachment of small particles on the surface of the channel or the change in surface characteristics of the channel according to time, it is also difficult to control a flow rate of the fluid.

### SUMMARY OF THE INVENTION

The present invention is directed to a microfluid control device controlling a microfluid using a multi-step microchannel and a method of manufacturing the same.

One aspect of the present invention provides a microfluid control device, including: a lower substrate, and a fluid channel substrate contacting the lower substrate and having a multi-step microchannel having at least two depths in a side coupling to the lower substrate.

Another aspect of the present invention provides a method of manufacturing the microfluid control device, including: forming a mold having a multi-step micropattern; forming a multi-step microchannel having at least two depths by transferring the multi-step micropattern of the mold to the fluid channel substrate; and coupling the fluid channel substrate having the multi-step microchannel to the lower substrate.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIGS. 1A and 1B illustrate a structure of a microfluid control device according to an exemplary embodiment of the present invention;

FIGS. 1C and 1D illustrate a principle of controlling a microfluid of a microfluid control device according to an exemplary embodiment of the present invention;

FIGS. 2A to 2F are cross-sectional views illustrating a method of forming a prototype of a mold according to an exemplary embodiment of the present invention;

FIG. 3 is a cross-sectional view illustrating a method of forming a mold according to an exemplary embodiment of the present invention;

FIGS. 4A to 4D are cross-sectional views illustrating a method of forming a fluid channel substrate according to an exemplary embodiment of the present invention; and

FIGS. 5A and 5B are cross-sectional views illustrating coupling of a fluid channel substrate to a lower substrate according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below, but can be implemented in various forms. For clarity, a part that is not related to the description of the present invention will be omitted, and similar part will be represented by a similar reference mark throughout the specification.

Throughout the specification, when a part “includes” or “comprises” a component, the part may include, not remove, another element, unless otherwise defined. In addition, the term “part” or “unit” used herein means a unit processing at least one function or operation.

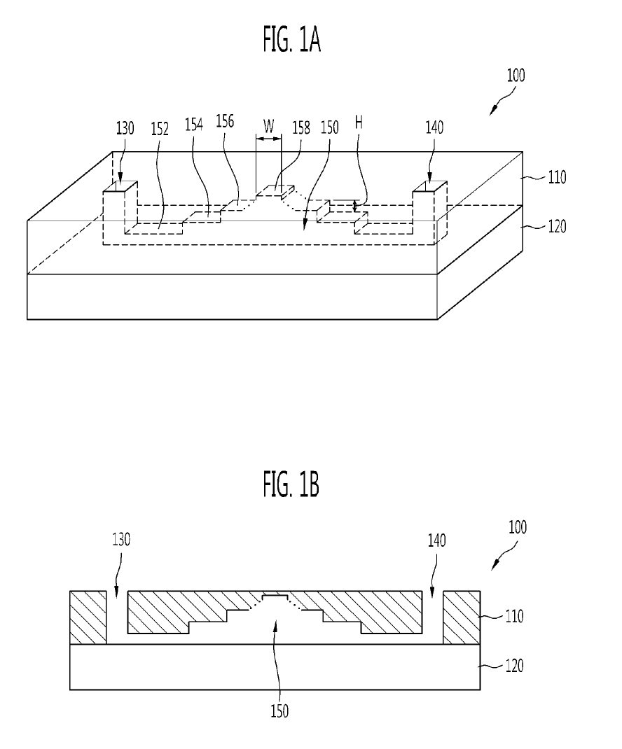

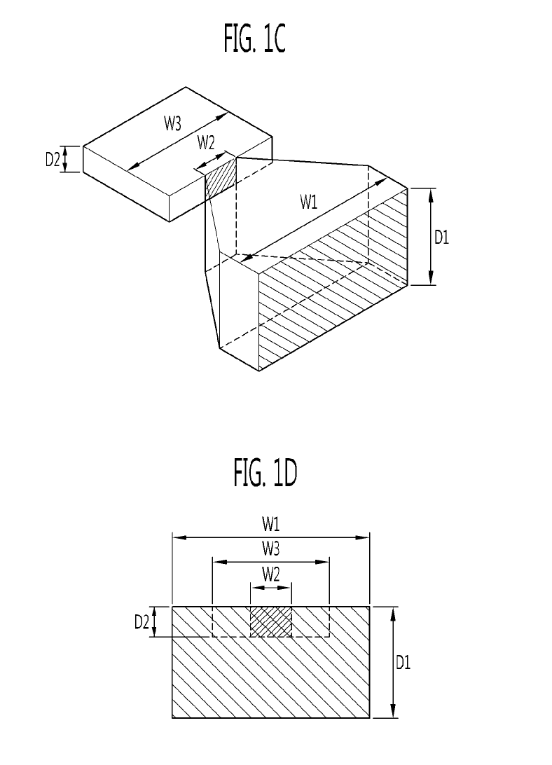

FIGS. 1A and 1B illustrate a structure of a microfluid control device according to an exemplary embodiment of the present invention. FIG. 1A is a perspective view and FIG. 1B is a cross-sectional view taken along line I-I′ of FIG. 1A.

As shown in FIGS. 1A and 1B, the microfluid control device 100 according to the exemplary embodiment of the present invention includes a lower substrate 120, and a fluid channel substrate 110 which is in contact with the lower substrate 120 and has a multi-step microchannel 150 having at least two depths in a coupling side with the lower substrate 120. Here, the fluid channel substrate 110 may further include a fluid inlet 130 and a fluid outlet 140, and a separate hole through which the air passes to help the fluid flow. The lower substrate 120 may further include a sensor and a reactor.

The fluid channel substrate 110 and the lower substrate 120 may be formed of polymers, which may have the same or different structures.

The multi-step microchannel 150 has various depths according to a position, and the depth of the channel is controlled by multiple steps. Here, widths (W) and heights (H) of the steps 152, 154, 156, and 158 may vary according to the purpose and application of the microfluid control device. Thus, due to the widths and heights of the steps 152, 154, 156, and 158, capillary force may be precisely controlled according to the position of the channel.

For example, as the channel is formed to have different depths at a portion for rapidly passing the fluid and at a portion for blocking the flow of the fluid because of the reaction, the fluid may be controlled with high precision and reproducibility. Thus, the height (H) of each step 152, 154, 156, or 158 may be 1 to 1000 μm, and the width (W) of each step 152, 154, 156, or 158 may be 1 to 100000 μm.

A surface of the multi-step microchannel 150 may be chemically or physically treated to control hydrophobicity or hydrophilicity.

FIGS. 1C and 1D illustrate a principle of controlling a microfluid of a microfluid control device according to an exemplary embodiment of the present invention. FIG. 1C is a perspective view of a multi-step microchannel, and FIG. 1D illustrates a cross-sectional view of the multi-step microchannel.

As shown in FIG. 1C, the microfluid control device 100 according to the exemplary embodiment of the present invention may be controlled in depths D1 and D2 of the microchannel. In other words, since the channel of the microfluid control device 100 may be formed in a multi-step structure having various depths, the capillary force may be controlled in a depth direction.

The microfluid control device 100 according to the exemplary embodiment of the present invention may be controlled in the depths D1 and D2 and the widths W1, W2 and W3 of the channel. Thus, the capillary force may be more precisely controlled by simultaneously controlling the widths W1 and W2 and depths D1 and D2 of the channel.

For example, in a section for increasing a flow rate of the fluid, the depth D1 and/or width W1 of the channel may be increased, thereby reducing the capillary force. In a section for blocking the flow of the fluid, a valving section, or decreasing a flow rate, the depth D2 and/or widths W2 and W3 of the channel are reduced, thereby raising the capillary force.

As shown in FIG. 1D, by simultaneously controlling the widths (W1>W3>W2) and depths (D1>D2) of the channel, the cross-section of the microchannel through which the microfluid passes may be effectively reduced. For example, compared to when the cross-sections of the microchannel (W1*D1>W3*D1>W2*D1) are reduced by only controlling the widths of the channel (W1>W3>W2), when the widths (W1>W3>W2) and depths (D1>D2) of the channel are simultaneously controlled, the cross-sections of the microchannel (W1*D1>W3*D1>W2*D1) may be effectively reduced.

Likewise, by using control factors in horizontal and vertical directions, the blocking, valving, passing and meeting of the fluid may be more precisely and reproducibly controlled. Particularly, in the case of a chip used for early diagnosis of a disease and chemical analysis in a biological microelectromechanical system (bio-MEMS), application of the multi-step microchannel according to the exemplary embodiment of the present invention can provide more precise analysis by precisely and reproducibly controlling an ultramicrofluid.

In addition, when the capillary force is controlled only in the horizontal direction, the width and shape of the channel have to be controlled, and thus a size of the chip may be increased. However, when the capillary force is also controlled in the vertical direction, the size of the chip may not be increased.

To manufacture a microfluid control device including a multi-step microchannel, machining or a semiconductor process may be used. However, according to the mechanical processing, the channel may have a rough surface, and thus the reproducibility in control of the fluid may be degraded. According to the semiconductor process, a smoother surface may be obtained, as compared to the mechanical processing, but the channel may be formed to have a depth of only 1 μm or less, and production costs become higher. As a result, productivity is lower than that of disposable plastic chip products. Hereinafter, a method of manufacturing a microfluid control device suitable for forming a multi-step microchannel will be described with reference to the accompanying drawings.

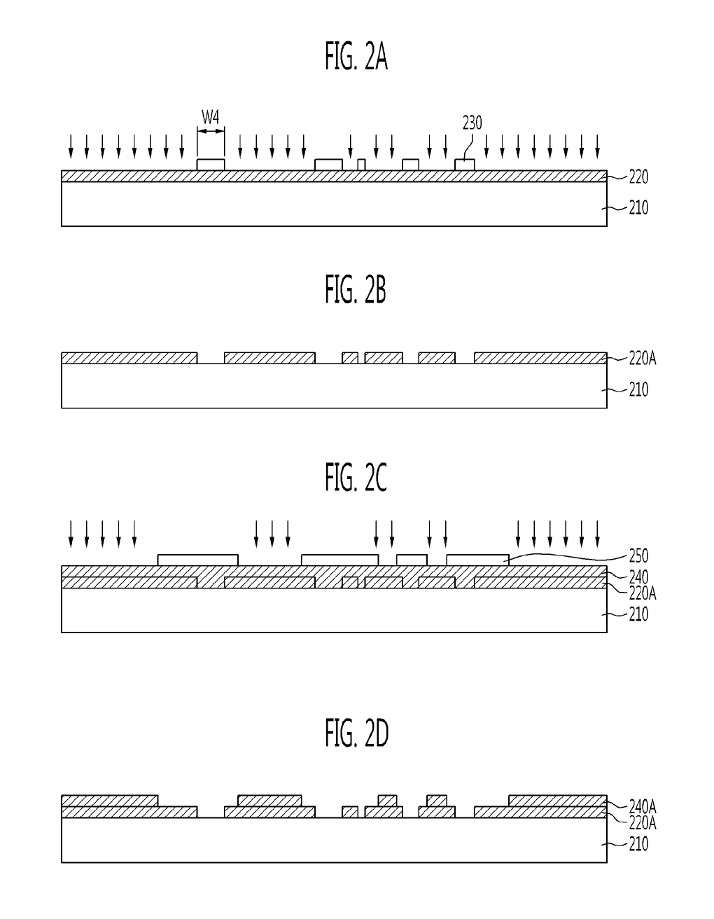

FIGS. 2A to 5B are cross-sectional views illustrating a method of manufacturing a microfluid control device according to an exemplary embodiment of the present invention.

According to the exemplary embodiment of the present invention, a mold prototype having a multi-step micropattern is formed, and a mold having a multi-step micropattern is formed using the mold prototype. Subsequently, a multi-step microchannel having at least two depths is formed by transferring the multi-step micropattern of the mold to a fluid channel substrate. Then, the fluid channel substrate having the multi-step microchannel is coupled to a lower substrate, and thereby the microfluid control device is completed.

According to the present invention, when the microfluid control device is manufactured by transferring the multi-step micropattern of the mold to the fluid channel substrate, the reproducibility in fluid control becomes high due to a smooth surface of the channel, and low production costs and high productivity are obtained. Since the depth of the channel may be controlled in various units from micrometers to centimeters, the capillary force is precisely controlled, and thus the fluid can be more precisely controlled.

FIGS. 2A to 2F are cross-sectional views illustrating a method of forming a mold prototype according to an exemplary embodiment of the present invention.

As shown in FIG. 2A, a photoresist 220 is applied to a silicon substrate 210, and a mask pattern 230 is formed on the photoresist 220.

Here, the photoresist 220 may be an epoxy-based photoresist. The epoxy-based photoresist 220 may easily form a desired pattern by exposure, is not damaged or deformed by additional exposure after thermal hardening, and can form a micropattern. An exemplary epoxy-based photoresist, SU-8-based photoresist, may be used.

A thickness of the applied photoresist 220 may be controlled according to viscosity of the photoresist, revolutions per unit of a spin coating apparatus, and time. For example, the photoresist 220 may be applied at a revolution speed of 500 to 5000 rpm, and may be formed to a thickness of 1 to 100 μm.

A width W of the micropattern is determined by a width W4 of a mask pattern 230, and the mask pattern 230 may have a width W2 of 1 to 100000 μm.

As shown in FIG. 2B, a first pattern 220A is formed using the mask pattern 230 as an etch barrier by exposure and development. Here, the formation of the first pattern 220A may be performed by photolithography having a resolution of 1 μm or more.

Subsequently, the first pattern 220A is solidified by thermal hardening process. Here, the thermal hardening process may be performed before and after the development.

As a result, the mold prototype having a micropattern is formed, and the multi-step micropattern may be formed by repeating a process including application of a photoresist, formation of a mask pattern, formation of a micropattern, and hardening.

As shown in FIG. 2C, a photoresist 240 is applied to the entire surface of the resulting product including the solidified first pattern 220A, and a mask pattern 250 is formed on the photoresist 240.

As shown in FIG. 2D, a second pattern 240A is formed using the mask pattern 250 as an etch barrier by exposure and development. Subsequently, the second pattern 240A is solidified by thermal hardening.

As shown in FIG. 2E, a photoresist 260 is applied to the entire surface of the resulting product including the solidified second pattern 240A, and a mask pattern 270 is formed on the photoresist 260.

As shown in FIG. 2F, a third pattern 260A is formed using the mask pattern 270 as an etch barrier. Subsequently, the third pattern 260A is solidified by thermal hardening.

As a result, a mold prototype 200 having a three-step micropattern is manufactured. Here, the number of steps of the micropattern may be controlled according to the number of times the process is repeated, and the shape of the micropattern may vary according to the shape of the mask pattern 230, 250 or 270.

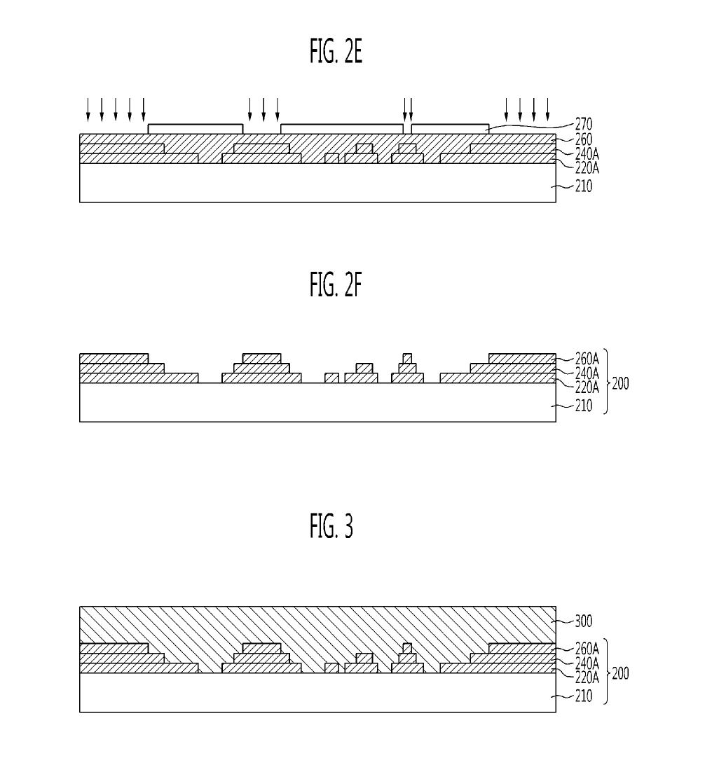

FIG. 3 is a cross-sectional view illustrating a method of forming a mold according to an exemplary embodiment of the present invention.

As shown in FIG. 3, a mold 300 is formed using the mold prototype 200 having the multi-step micropattern. For example, a metal mold may be formed by electroplating. In detail, a seed thin film may be formed on the mold prototype 200, and the metal mold may be formed by electroplating.

Here, the seed thin film may be formed of a metal such as Ti, Cr, Al, or Au so as to have a single layer or double layer. The mold 300 may be formed to have a sufficient thickness so that is not bent or broken in a subsequent transferring process.

Then, although not shown in the drawing, the mold prototype 200 is removed by wet etching.

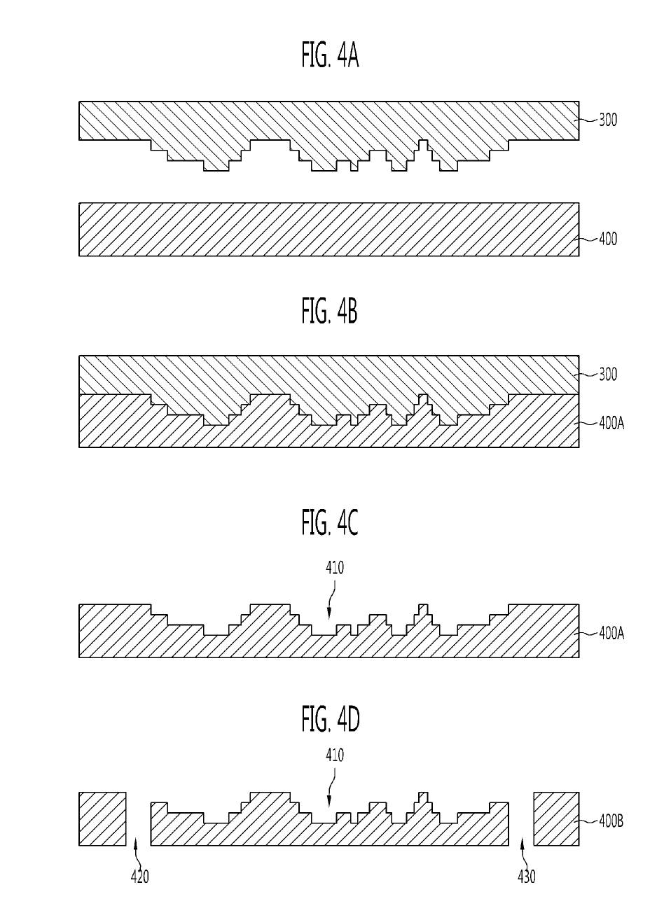

FIGS. 4A to 4D are cross-sectional views illustrating a method of forming a fluid channel substrate according to an exemplary embodiment of the present invention.

As shown in FIG. 4A, the mold 300 including the multi-step micropattern and a substrate 400 for transferring the multi-step micropattern formed on a surface of the mold 300 are prepared.

Here, the substrate 400 may be a polymer substrate, which may be formed of a cyclo olefin copolymer (COC), polymethylmethacrylate (PMMA), polycarbonate (PC), a cyclo olefin polymer (COP), a liquid crystalline polymer (LCP), polydimethylsiloxane (PDMS), polyamide (PA), polyethylene (PE), polyimide (PI), polypropylene (PP), polyphenylene ether (PPE), polystyrene (PS), polyoxymethylene (POM), polyetheretherketone (PEEK), polyethylenephthalate (PES), polyethylenephthalate (PET), polytetrafluoroethylene (PTFE), polyvinylchloride (PVC), polyvinylidene fluoride (PVDF), polybutyleneterephthalate (PBT), fluorinated ethylenepropylene (FEP), perfluoralkoxyalkane (PFA), or a composite thereof.

The substrate 400 may be formed by injection molding, hot embossing, casting, stereolithography, laser ablation, rapid prototyping, silk screening, conventional machine processing such as numerical control machining, or semiconductor processing such as photolithography.

As shown in FIG. 4B, the multi-step micropattern of the mold 300 is transferred to the substrate 400.

For example, when the substrate 400 formed of a polymer is used, the multi-step micropattern may be transferred using injection molding, hot embossing or casting. As a result, the multi-step micropattern having a complicated shape may be easily transferred to the polymer substrate 400, and thus a fluid channel substrate 400A having the multi-step microchannel may be completed. As described above, when the multi-step microchannel is formed on the polymer substrate 400 by transferring, the channel can be formed to have depths ranging from several micrometers to centimeters.

As shown in FIG. 4C, after the transfer of the multi-step micropattern to the fluid channel substrate 400A is completed, the mold 300 is removed. In the drawing, the multi-step microfluid channel formed on the fluid channel substrate 400A is indicated by a reference numeral “410.”

As shown in FIG. 4D, the fluid channel substrate 400A is etched to form a fluid inlet 420 for injecting a fluid, and a fluid outlet 430 for exhausting a fluid. In the drawing, the fluid channel substrate having the fluid inlet 420 and the fluid outlet 430 is indicated by a reference numeral “400B.” In addition, although not shown in the drawing, a hole for passing air may be further formed.

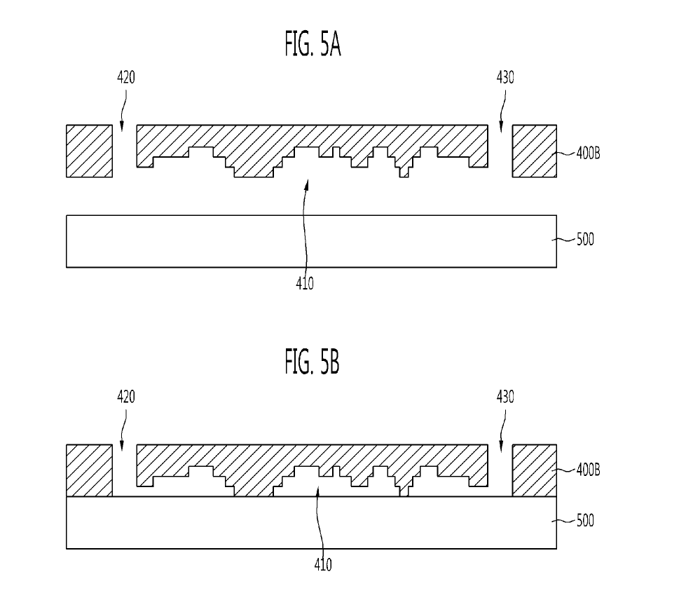

FIGS. 5A and 5B are cross-sectional views illustrating coupling of the fluid channel substrate to a lower substrate according to an exemplary embodiment of the present invention.

As shown in FIG. 5A, the fluid channel substrate 400B having the multi-step microfluid channel 410 and a lower substrate 500 are prepared.

Here, the lower substrate 500 may be formed of a polymer like the fluid channel substrate 400B. The fluid channel substrate 400B and the lower channel 500 may be formed of the same or different polymer structure. Examples of materials for the lower substrate 500 are the same as those for the fluid channel substrate 400 described above.

The fluid channel substrate 400B and the lower substrate 500 may be formed of materials having the same hydrophobicity or hydrophilicity, or having different hydrophobicity or hydrophilicity. Alternatively, parts of the surfaces of the fluid channel substrate 400B and the lower substrate 500 may be formed of materials having different hydrophobicity or hydrophilicity. Likewise, as the surface modification of the fluid channel substrate 400B and the lower substrate 500 may be controlled, a flow rate of the fluid may be controlled.

As shown in FIG. 5B, a microfluid control device is manufactured by coupling the fluid channel substrate 400B to the lower substrate 500.

Here, when the fluid channel substrate 400B and the lower substrate 500 are formed of the same material, the coupling of the fluid channel substrate 400B to the lower substrate 500 may be performed by a fusion adhering method using heat, chemicals, or ultrasonic waves.

When the fluid channel substrate 400B and the lower substrate 500 are formed of different materials, the coupling of the fluid channel substrate 400B to the lower substrate 500 may be performed using a liquid-type adhesive material, a powdery adhesive material, or a paper-like thin film-type adhesive material.

Particularly, a UV hardening agent may be used. Furthermore, room temperature or low temperature can be required to prevent modification of biochemical materials during coupling, in this case, a pressure sensitive adhesive carrying out the coupling with only pressure may be used.

According to the present invention, a microfluid control device adjusts capillary force in a channel depth direction and precisely controls flow of a fluid by controlling the fluid using a multi-step microchannel having various depths. Further, the multi-step microchannel whose surface is even and whose height is precisely controlled may be easily formed by forming a multi-step micropattern by repeating photolithography and transferring the micropattern.

Thus, the fluid may be controlled with reproducibility and precision using a vertical multi-step ultramicrostructure. The microfluid control device and a method of manufacturing the same according to the present invention can be applied to various lab-on-a-chip bio devices including protein chips, DNA chips, drug delivery systems, micro total analysis systems, and biochemical micro reactors.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A microfluid control device, comprising:
a lower substrate; and
a fluid channel substrate contacting the lower substrate and having a multi-step microchannel having at least two depths in a side coupling to the lower substrate.

2. The device of claim 1, wherein the multi-step microchannel is controlled in capillary force in a depth direction of the channel.

3. The device of claim 1, wherein the multi-step microchannel has one step, a depth of which is 1 to 1000 μm.

4. The device of claim 1, wherein the multi-step microchannel has one step, a width of which is 1 to 100000 μm.

5. The device of claim 1, wherein the fluid channel substrate and the lower substrate are formed of the same or different polymer structures.

6. The device of claim 1, wherein a surface of the multi-step microchannel is chemically treated to control hydrophobicity or hydrophilicity.

7. A method of manufacturing a microfluid control device, comprising:
forming a mold having a multi-step micropattern;
forming a multi-step microchannel having at least two depths by transferring the multi-step micropattern of the mold to the fluid channel substrate; and
coupling the fluid channel substrate having the multi-step microchannel to the lower substrate.

8. The method of claim 7, wherein the fluid channel substrate and the lower substrate are formed of the same or different polymers.

9. The method of claim 7, wherein the fluid channel substrate is coupled to the lower substrate using an adhesive or ultrasonic bonding.

10. The method of claim 7, wherein the formation of the mold comprises:
forming a mold prototype having a multi-step micropattern; and
forming a metal mold using the mold prototype by electroplating.

11. The method of claim 10, wherein the formation of the mold prototype comprises:
applying a photoresist to a surface of a silicon substrate;
forming a micropattern by patterning the photoresist; and
hardening the micropattern,
wherein the application of the photoresist, the formation of the mask pattern, the formation of the micropattern, and the hardening are repeated to form the multi-step micropattern.

12. The method of claim 11, wherein the photoresist is an epoxy- or SU-8-based photoresist.

13. The method of claim 10, wherein the formation of the metal mold comprises:
forming a seed thin layer on the mold prototype;
forming the metal mold by electroplating; and
removing the mold prototype by wet etching.

14. The method of claim 7, wherein the transfer is performed by injection molding, hot embossing, or casting.
